(19) United States
(12) Patent Application Publication
(10) Pub. No.: US 2016/0094773 A1
(43) Pub. Date: Mar. 31, 2016

(54) Collaborative Image Collection And Processing Using Portable Cameras

(71) Applicant: Apple Inc., Cupertino, CA (US)

(72) Inventors: Dragos B. Maciuca, Mountain View, CA (US); Richard L. Baer, Los Altos, CA (US)

(21) Appl. No.: 14/500,714

(22) Filed: Sep. 29, 2014

(51) Int. Cl. H04N 5/232; H04N 5/262

(52) U.S. Cl. CPC H04N 5/23206; H04N 5/23216; H04N 5/23293; H04N 5/2624

(57) ABSTRACT

A system and method for capturing image information from multiple camera devices, either simultaneously or in an organized sequence. A group of cameras may act in collaboration with each other to capture multiple images of a single subject or multiple subjects. The resulting images may be combined to form a single product that is richer in content than any one of the cameras could create alone. User interfaces for control and management of the group imaging sessions allow for flexible and easy use of smartphones as cameras.

### BACKGROUND

A single camera used to take an image or video provides a single perspective on a subject, which is both literally and figuratively a single point of view. If multiple images are taken of the same subject, more information regarding the subject may be collected. If the images are numerous and are taken at varying positions or angles with respect to the subject, the aggregate of the images contains depth and perspective information that is not possible to obtain from a single normal camera.

The common use of smart phones and tablets has widely distributed cameras (as integrated with general purpose computers) among the general public. Due to this wide distribution, at any event or attraction, many individuals have cameras on their person. This creates infinite opportunities to collect multiple images of any interesting subject. By coordinating only a small fraction of the camera-carrying users and their cameras, each user may be able to capture better or more interesting images and video that are derived from a plurality of images or video captured by a plurality of devices.

### SUMMARY

Varying embodiments of the invention relate to collaborative imaging sessions of projects where several devices such as smartphones perform image captures under supervisory control for the purpose of creating a combined image. In some embodiments, in order to perform a collaborative imaging session, a group of participating nodes must be identified. One or more embodiments may identify nodes by using network service discovery tools such as BONJOUR® or by using a registration system.

Once a group of nodes is assembled, some embodiments allow for supervisory control of the group. The supervisory node may be a server, or any type of computer including an imaging participant in the collaborative imaging project. In one embodiment, the supervisory node will examine preview information and provide feedback to supervised nodes to adjust their positioning or other settings. When the positions and image previews are deemed suitable, the supervisory node will initiate an image capture, which may happen simultaneously or in a sequence.

In varying embodiments, the captured images are collected for processing to form a combined image, which may, for example, be a stitched image or a collage. The combined image may reflect more or better information than any one node could capture individually

### BRIEF DESCRIPTION OF THE DRAWINGS

FIG. 1 illustrates an example computing environment for a camera node, supervisory node, or server.

FIG. 2 illustrates a sample network.

FIG. 3 illustrates a sample software architecture or layer diagram.

FIG. 4 shows an example embodiment of camera nodes communicating with each other and with one or more servers.

FIGS. 5a, 5b, and 5c show example configurations for the positioning of cameras and subjects in a collaborative imaging session.

FIG. 6 shows a general process followed to employ a collaborative imaging group.

FIGS. 7a and 7b show example user interfaces for identifying members or potential members of a collaborative imaging group.

FIG. 8 shows an example user interface for a supervising node.

FIG. 9 shows an example user interface for a supervising node.

FIG. 10 shows an example user interface for a supervised node.

FIG. 11 shows a process associated with some embodiments of the invention.

### DETAILED DESCRIPTION

The inventive embodiments described herein may have implication and use in and with respect to all types of devices, including single- and multi-processor computing systems and vertical devices (e.g. cameras or appliances) that incorporate single- or multi-processing computing systems. The discussion herein references a common computing configuration having a CPU resource including one or more microprocessors. The discussion is only for illustration and is not intended to confine the application to the disclosed hardware. Other systems having other known or common hardware configurations (now or in the future) are fully contemplated and expected. With that caveat, a typical hardware and software operating environment is discussed below. The hardware configuration may be found, for example, in a server, a laptop, a tablet, a desktop computer, a smart phone, a phone, or any computing device, whether mobile or stationary.

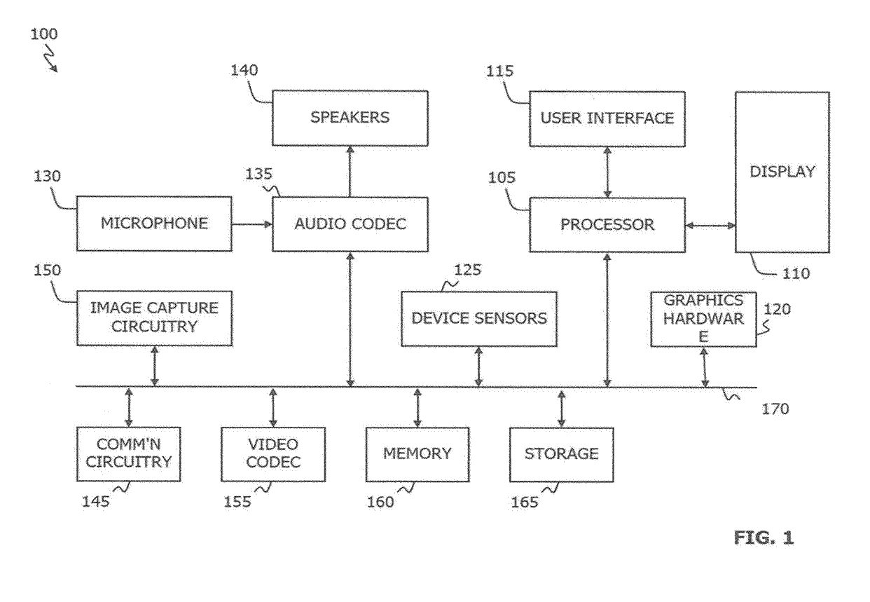

Referring to FIG. 1, a simplified functional block diagram of illustrative electronic device 100 is shown according to one embodiment. Electronic device 100 could be, for example, a mobile telephone such as a smartphone, personal media device, portable camera, or a tablet, notebook, or desktop computer system or even a server. As shown, electronic device 100 may include processor 105, display 110, user interface 115, graphics hardware 120, device sensors 125 (e.g., GPS, proximity sensor, ambient light sensor, accelerometer and/or gyroscope), microphone 130, audio codec(s) 135, speaker(s) 140, communications circuitry 145, image capture circuitry 150 (e.g. camera), video codec(s) 155, memory 160, storage 165 (e.g. hard drive(s), flash memory, optical memory, etc.) and communications bus 170. Communications circuitry 145 may include one or more chips or chip sets for enabling cell-based communications (e.g., LTE, CDMA, GSM, HSDPA, etc.) or other communications (WiFi, Bluetooth, USB, Thunderbolt, Firewire, etc.). Electronic device 100 may be, for example, a personal digital assistant (PDA), personal music player, a mobile telephone, or a notebook, laptop, tablet computer system, or any desirable combination of the foregoing.

Processor 105 may execute instructions necessary to carry out or control the operation of many functions performed by device 100 (e.g., such as to control one or more cameras and to run software applications like games, productivity software, and low level software such as frameworks). In general, many of the functions described herein are based upon a microprocessor acting upon software (instructions) embodying the function. The software instructions may be written in any known computer language and may be in any form including compiled or clear text. The instructions may be stored on any known media such as magnetic memory disks, optical disks or FLASH memory and other similar semiconductor-based media devices. Processor 105 may, for instance, drive display 110 and receive user input from user interface 115. User interface 115 can take a variety of forms, such as a button, keypad, dial, a click wheel, keyboard, display screen and/or a touch screen, or even a microphone or camera (video and/or still) to capture and interpret input sound/voice or images including video. The user interface 115 may capture user input for any purpose including management of a camera-related application and supervisory control of remote devices including remote cameras.

Processor 105 may be a system-on-chip, such as those found in mobile devices, and may include a dedicated graphics processing unit (GPU). Processor 105 may be based on reduced instruction-set computer (RISC) or complex instruction-set computer (CISC) architectures or any other suitable architecture and may include one or more processing cores. Graphics hardware 120 may be special purpose computational hardware for processing graphics and/or for assisting processor 105 to process graphics information. In one embodiment, graphics hardware 120 may include one or more programmable graphics processing units (GPU).

Image capture circuitry 150 includes a variety of camera components, known to the skilled artisan, such as an image sensor (e.g. CCD or CMOS). While not shown in the diagram, image capture circuitry 150 may be associated with a camera optical system including one or more lenses and the capability to adjust focus and aperture, either manually or automatically. The image sensor is in optical communication with the lens system so that light arriving on the sensor may form a desirable image. Furthermore, the activity of the image sensor may be controlled by operation of the processor in response to software instructions.

Sensors 125 and camera circuitry 150 may capture contextual and/or environmental phenomena such as location information; the status of the device with respect to light, gravity, and the magnetic north; and even still and video images. All captured contextual and environmental phenomena may be used to provide context for images captured by the camera. Output from the sensors 125 or camera circuitry 150 may be processed, at least in part, by video codec(s) 155 and/or processor 105 and/or graphics hardware 120 and/or a dedicated image processing unit incorporated within circuitry 150. Information so captured may be stored in memory 160 and/or storage 165 and/or in any storage accessible on an attached network. Memory 160 may include one or more different types of media used by processor 105, graphics hardware 120, and image capture circuitry 150 to perform device functions. For example, memory 160 may include memory cache, electrically erasable memory (e.g., flash), read-only memory (ROM), and/or random access memory (RAM). Storage 165 may store data such as media (e.g., audio, image, and video files), metadata for media, computer program instructions, or other software; including database applications, preference information, device profile information, and any other suitable data. Storage 165 may include one more non-transitory storage media including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 160 and storage 165 may be used to retain computer program instructions or code organized into one or more modules in either compiled form or written in any desired computer programming language. When executed by, for example, processor 105, such computer program code may implement one or more of the acts or functions described herein.

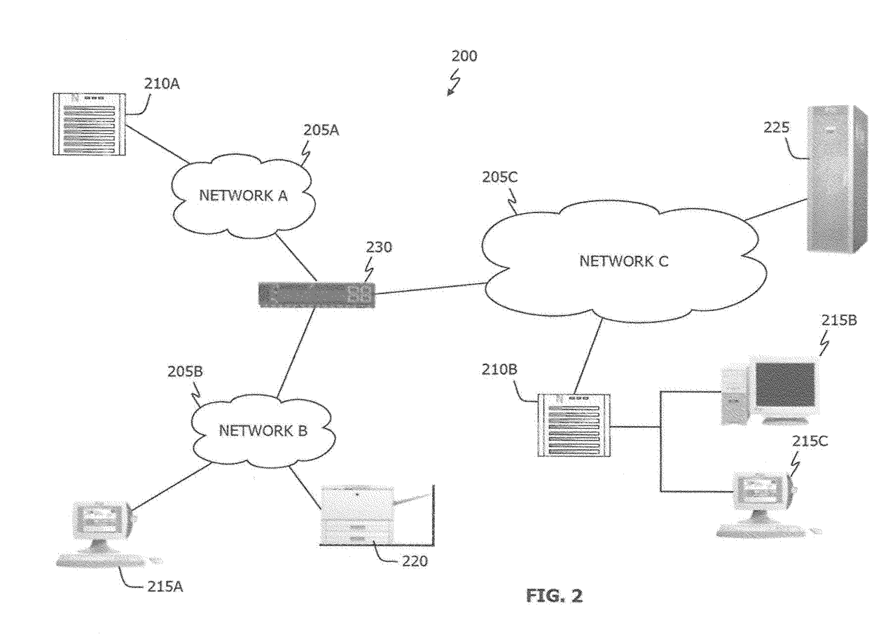

Referring now to FIG. 2, illustrative network architecture 200, within which the disclosed techniques may be implemented, includes a plurality of networks 205, (i.e., 205A, 205B and 205C), each of which may take any form including, but not limited to, a local area network (LAN) or a wide area network (WAN) such as the Internet. Further, networks 205 may use any desired technology (wired, wireless, or a combination thereof) and protocol (e.g., transmission control protocol, TCP). Coupled to networks 205 are data server computers 210 (i.e., 210A and 210B) that are capable of operating server applications such as databases and also capable of communicating over networks 205. One embodiment using server computers may involve the operation of one or more central systems to collect multiple images and to process the multiple images into a single image representation such as a collage, stitched image, or image fusion.

Also coupled to networks 205, and/or data server computers 210, are client computers 215 (i.e., 215A, 215B and 215C), which may take the form of any smartphone, tablet, computer, set top box, entertainment device, communications device, or intelligent machine, including embedded systems. In some embodiments, users will employ client computers in the form of smart phones or tablets that include cameras. In some embodiments, network architecture 210 may also include network printers such as printer 220 and storage systems such as storage system 225, which may be used to store multi-media items (e.g., images) that are referenced herein. To facilitate communication between different network devices (e.g., data servers 210, end-user computers 215, network printer 220, and storage system 225), at least one gateway or router 230 may be optionally coupled therebetween. Furthermore, in order to facilitate such communication, each device employing the network may comprise a network adapter circuit and related software. For example, if an Ethernet network is desired for communication, each participating device must have an Ethernet adapter or embedded Ethernet capable ICs. Further, the devices may carry network adapters for any network in which they will participate (including PANs, LANs, WANs and cellular networks).

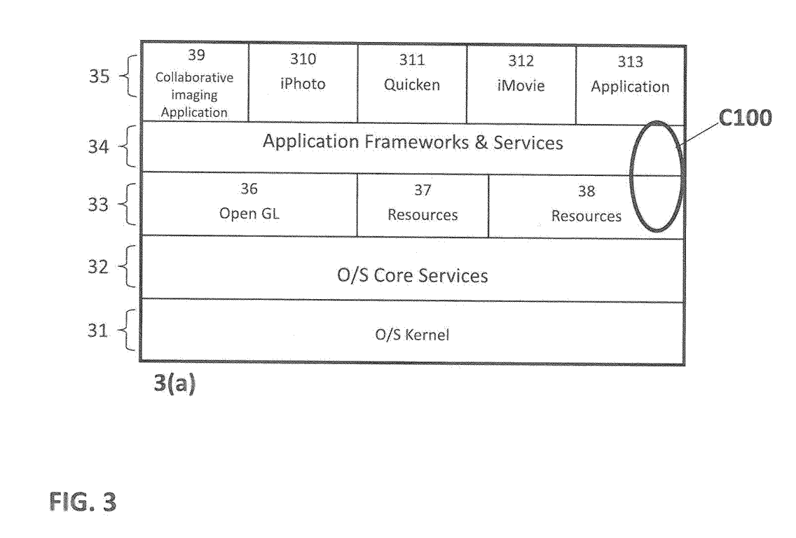

As noted above, embodiments of the inventions disclosed herein include software. As such, a general description of common computing software architecture is provided as expressed in layer diagrams of FIG. 3. Like the hardware examples, the software architecture discussed here is not intended to be exclusive in any way but rather to be illustrative. This is especially true for layer-type diagrams, which software developers tend to express in somewhat differing ways. In this case, the description begins with layers starting with the O/S kernel, so lower level software and firmware has been omitted from the illustration but not from the intended embodiments. The notation employed here is generally intended to imply that software elements shown in a layer use resources from the layers below and provide services to layers above. However, in practice, all components of a particular software element may not behave entirely in that manner.

With those caveats regarding software, referring to FIG. 3, layer 31 is the O/S kernel, which provides core O/S functions in a protected environment. Above the O/S kernel is layer 32 O/S core services, which extends functional services to the layers above, such as disk and communications access. Layer 33 is inserted to show the general relative positioning of the Open GL library and similar application and framework resources. Layer 34 is an amalgamation of functions typically expressed as multiple layers: application frameworks and application services. For purposes of discussion, these layers provide high-level and often functional support for application programs which reside in the highest layer shown here as layer 35. Item C100 is intended to show the general relative positioning of the framework and low level software discussed with respect to embodiments herein. In particular, in some embodiments, frameworks and low level software provide an imaging collaboration application with assistance in establishing communications and analyzing and processing images. While the ingenuity of any particular software developer might place the functions of the software described at any place in the software stack, the software hereinafter described is generally envisioned as all of: (i) user interfacing application software, for example, to present user interfaces to camera users; (ii) as a utility, or set of functions or utilities, beneath the application layer, supporting collaborative imaging by any application; and (iii) as one or more server applications for aiding in communications and processing in assembling a collaborative imaging group and completing a collaborative imaging project. Furthermore, on the server side, certain embodiments described herein may be implemented using a combination of server application level software and database software, with either possibly including frameworks and a variety of resource modules.

In the application layer 35 of the software stack shown in FIG. 3, there are shown a variety of software applications such as collaborative imaging application 39, IPHOTO® 310 (Photo organizing and editing software), QUICKEN® 311 (financial organization software), IMOVIE® 312 (video organizing and editing software) and other application 313. Other application 313 may include any type of software including any of the titles currently distributed through Apple's App store for MAC® or iOS. Same sample software applications that are relevant to this disclosure are Internet browsers and productivity applications like calendar and reminder software.

No limitation is intended by these hardware and software descriptions and the varying embodiments of the inventions herein may include any manner of computing device such as MACs®, PCs, PDAs, phones, servers, or even embedded systems.

### Collaborative Imaging.

Some embodiments seek to assemble multiple images that are sourced from multiple cameras so the images may be fused or otherwise combined to create a result that is more interesting or more information-rich than any one camera can produce. Some embodiments collect images or video from node-members of a collaborative imaging group where the pictures or video are captured during a collaborative imaging session or a collaborative imaging project. Differing embodiments may employ a camera that includes or is part of a general-purpose computer. In these embodiments, the general-purpose computer may be programmed to aid the functionality in collaborative imaging arrangement, employing a plurality of cameras/nodes. For example, the general purpose computer may be programmed to: control one or more cameras integral with the computer; provide for communication with Internet or other network-based resources; provide for direct or indirect communication among and between any members of the collaborative group; process images; and, simultaneously run a large number of software programs that are both related to and unrelated to photo/video capture and imaging.

Some examples of general-purpose computers that are suitable for use with certain embodiments are smartphones and tablets. A popular line of such devices is produced by Apple Inc. The Apple devices are commonly known as iOS devices, which include the Apple IPHONE® and IPAD® product lines. Smartphone and tablet platforms work well with many disclosed embodiments because they include cameras and the computing and communications infrastructure necessary for synchronizing and coordinating activity between the cameras. In some embodiments employing general-purpose computers such as smartphones and tablets, each computer runs one or more software programs for managing the activity related to the collaborative imaging arrangement. For example, the software may be capable of: presenting a GUI to receive settings and provide information to users; allowing for user control and provide for user feedback; sending or receiving communications via networks such as Bluetooth, Wi-Fi, LTE, UMTS, etc.; determining and applying camera settings; triggering an integral camera or any camera in the group to capture an image; processing images (including combining images) and sharing the images.

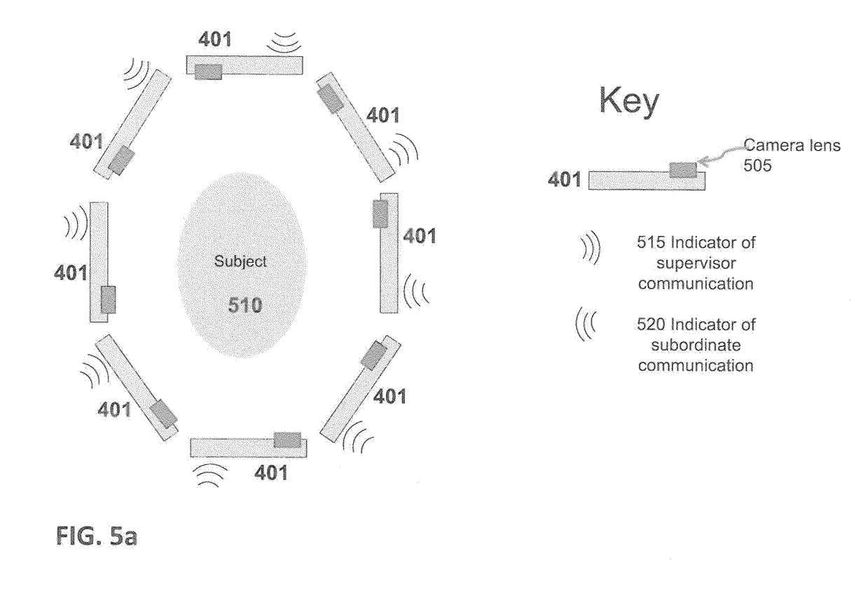

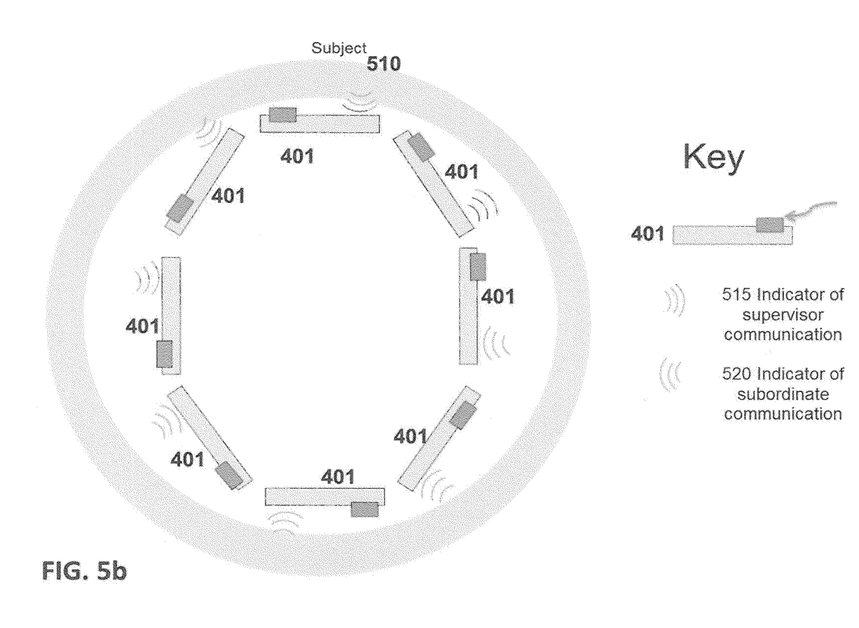

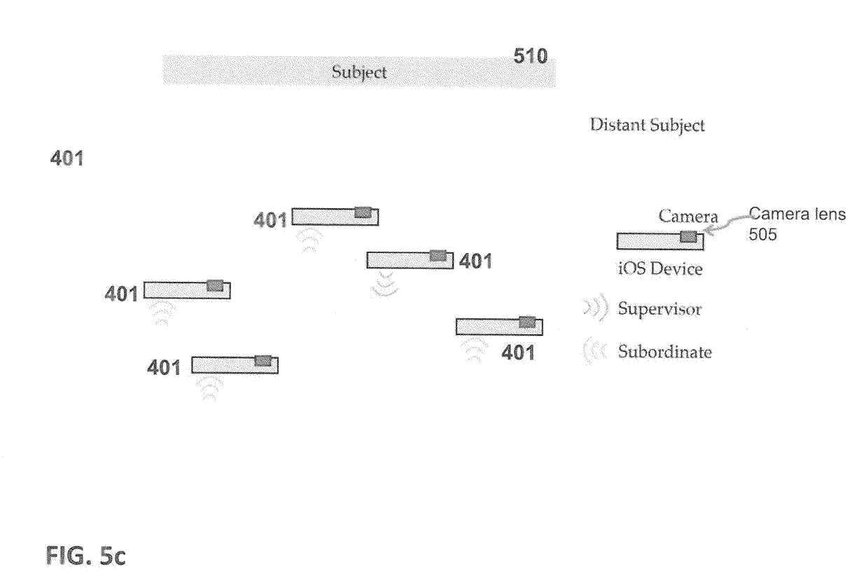

FIG. 5a shows a sample configuration that users may choose for a collaborative imaging project. The subject of the imaging project is subject 505 that is positioned in the center of eight cameras 401, each having a lens 505 facing the subject. As discussed herein, the cameras 401 may be integral with computers and, in some embodiments, smartphones and/or tablets may be employed. To aid the collaborative imaging project, the cameras 401 communicate with each other using various communications capabilities including personal area networks, local area networks, or wide area networks. As shown in FIG. 5a, each camera 401 has an indicator of communication capability 515 or 520. The graphic representation in FIG. 5a is intended to illustrate the use of a supervisory node that manages or controls (depending upon the embodiment) the collaborative imaging project. In particular, the supervisory node is shown by 515 indicator of supervision communication, and the subordinate nodes are shown by 520 indicator of subordinate communication. In some embodiments, all the cameras 401 are expected to communicate bi-directionally at least with a supervisory node, which may be one of the cameras, as illustrated, but also may be an Internet/network-based server or any other computer that can communicate with the cameras 401.

Referring to FIG. 5b, another potential configuration is shown for a group imaging project. In the illustration of FIG. 5b, the subject 510 is outside a ring of cameras 401 that may capture a 360 degree view of the subject (e.g. a landscape or a stadium from the inside, out). FIGS. 5a and 5b are intended to be merely illustrative and the invention contemplates embodiments where cameras are arranged in any relationship to a subject or to multiple physical subjects that may be dispersed across wide geographies, or not dispersed at all (e.g. at a single event or location).

### Enabling Devices to Participate in Collaborative Image Sharing.

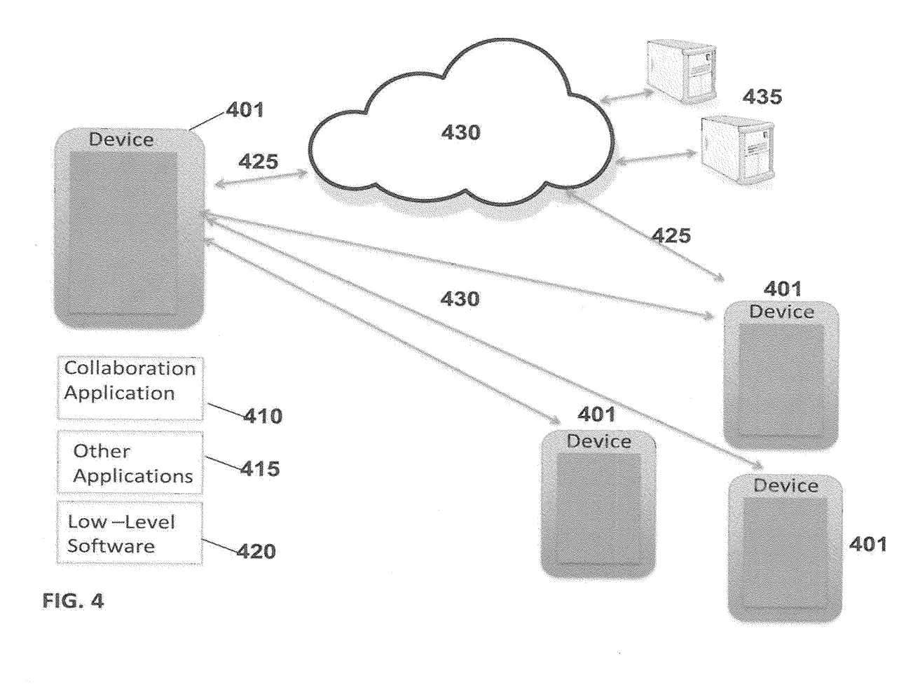

Referring now to FIG. 4, there is shown a high-level diagram describing how some embodiments of the invention obtain resources and share information. In addition, FIG. 4 demonstrates certain types of software found in varying embodiments. With reference to FIG. 4, device 401 is a client device that is pictured as a mobile device but may represent any type of device that a user may employ to run software. Device 401 may include any of the hardware forms discussed above and may run any of the software discussed above. However, device 401 is illustrated in FIG. 4 to include at least a collaboration application 410, other applications 415, and other software 420. The collaboration application 410 represents a software application program run on device 401 to enable some or all of the functionality desirable to participate in a collaborative imaging project. The collaboration application 410 may be loaded on the device 401 in any known manner including by purchase and download from an app store that is associated with the device. In some embodiments, the collaboration application 410 may be a cross-platform application and/or may be available to support many different types of hardware, such as smartphones and tablets running disparate operating systems.

Referring again to FIG. 4, in some embodiments, other applications 415 represents application programs present on device 401 other than the collaboration application 410. Some of the other applications 415 may relate to imaging or collaborative imaging and may be complementary or enabling to the function of collaboration application 410. Examples of these applications are photo or video browsing and editing software, productivity software (such as calendar an reminder software), social networking software, and Internet browsing software. Some of the other applications 415 may not relate to imaging or collaborative imaging at all. For example, as a general-purpose computer, device 401 may use gaming software, unrelated productivity software, utility software, or any other type of software that might be found on a business or consumer computer.

As discussed above, device 401 may carry a software arrangement such as the software discussed with respect to FIG. 3. In particular, FIG. 4 illustrates low-level software 420, which represents the software layers below the applications such as frameworks and operating system services. Collaboration software 410 may perform any of its function by using interfaces to the low-level software 420. For example, in order to form a collaborative imaging group, several devices may need to communicate between and amongst each other. Any portion of the connection with other devices and the maintenance of those connections may be through services in low-level software 420. One example of this type of software that may be used to aid in discovery and connection to other devices is Apple's BONJOUR® software, which may serve as a network services discovery tool to locate other devices.

For many embodiments, communication among devices in a collaborative group may be a necessary function to the task of collaborative imaging. Varying embodiments envision differing ways to route shared information. There are three general ways for nodes to communicate between and amongst themselves: directly with each other without intermediary computers or networking equipment; indirectly but over local area networks such as WiFi; and, indirectly over wide are networks such as the Internet. For purposes of this discussion, indirect communications over a local network are analogous to path 430 shown in FIG. 4 and explained below. Moreover, indirect communications that begin through a local area network but ultimately traverse a wide area network are analogous to path 425 shown in FIG. 4 and discussed below.

As show in FIG. 4, in some embodiments, devices 401 may communicate directly with each other, for example, using route 430. This technique may be useful when the devices are in closer proximity to each other such that standard smartphone LAN and PAN networking capabilities may be employed (e.g. Bluetooth, WiFi, etc.). As an alternative, or an additional capability, devices 410 may communicate through a wide area network like the Internet (e.g. path 425), which is often readily accessible from smartphone and tablet devices via cellular technologies such as LTE, UMTS, GPRS, CDMA, HSDPA, etc. While communication over path 425 may be desirable in a variety of situations, one common use is where devices 401 are geographically distributed beyond the reach of local area networks and personal area networks such as WiFi and Bluetooth. Of course, given appropriate infrastructure, any device may employ local or personal area networks to connect with a wide area network such as the Internet. In addition, some collaborative imaging projects may involve one or more groups of devices in close enough proximity to use path 430 as well as outlying devices that must communicate with the group through path 425.

In certain embodiments, communications path 425 may be used to access network-based resources represented by servers 435. For example, the network may be used for image processing or communication purposes. In some embodiments, a server-based service available over the network may allow group members to find each other and to form a group as discussed below. In some embodiments, path 425 may be used so that servers 435 can perform intermediary processing before forwarding information to another device 401 within a collaborative group. For example, when transporting image information, it may be desirable to allow servers 435 to perform image processing rather than the source or destination device. Such an arrangement may conserve time or the nodes' battery power, processor, and memory availability. As discussed below, some collaborative imaging embodiments involve combining images in any of a variety of ways. Since certain types of image combinations, such as fusing or stitching, can be intensive from the standpoint of processing resources, some embodiments perform some or all of the image combining at servers 435 (e.g. each device 401 forwards image information to servers 435 and some or all of the devices receive a final fused image or video in preview or final form).

In addition to or in lieu of the collaboration application 410, devices 401 may also be enabled for collaborative imaging largely through other applications 415 and/or low-level software 420. For example, APIs and frameworks may enable collaborative imaging functionality, and users may interact with that functionality through software and mechanisms pre-installed in the device, perhaps with the aid of a plugin (e.g. bundled photo, camera software, or an Internet browser application).

### A General Process.

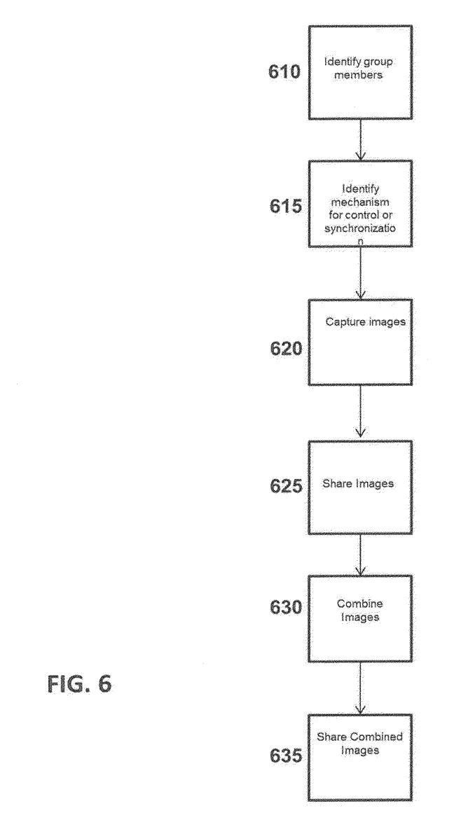

Referring to FIG. 6, a high level process is shown for a collaborative imaging project. The process may be implemented by any capable device including a general-purpose computer that is transformed by the process into a collaborative imaging device. At 610, members of a collaborative imaging group are identified. Group members may be identified using any known approach. For example, a group of friends or acquaintances may decide to engage in one or more group imaging projects at a museum or event. In one such embodiment, users desiring to be part of a collaborative image project can indicate their interest through the user interface of the collaboration application 410 (or other software such as a web browser). For example, either through a preference or other application selection, a user may indicate a desire to join a collaborative imaging group. In addition to indicating a desire to participate in a group, the user may also enter or select (e.g. from a dropdown list) more detailed information, such as specific subject desired (e.g. “Mona Lisa”), a general desired subject (e.g. “football”), a picture of the desired subject, or any other information that will help users find and identify each other. The information entered or selected by the user may be employed along with other information from the device (e.g. device ID or sensor data) to find other interested users. The skilled artisan will know many systems for discovering other interested user/devices over the available networks. For example, user/device interest (and other data discussed) may be registered with a server and the server may be queried to find other members. As another example, network services such as Apple's BONJOUR® may be used to advertise devices and their interest to other devices.

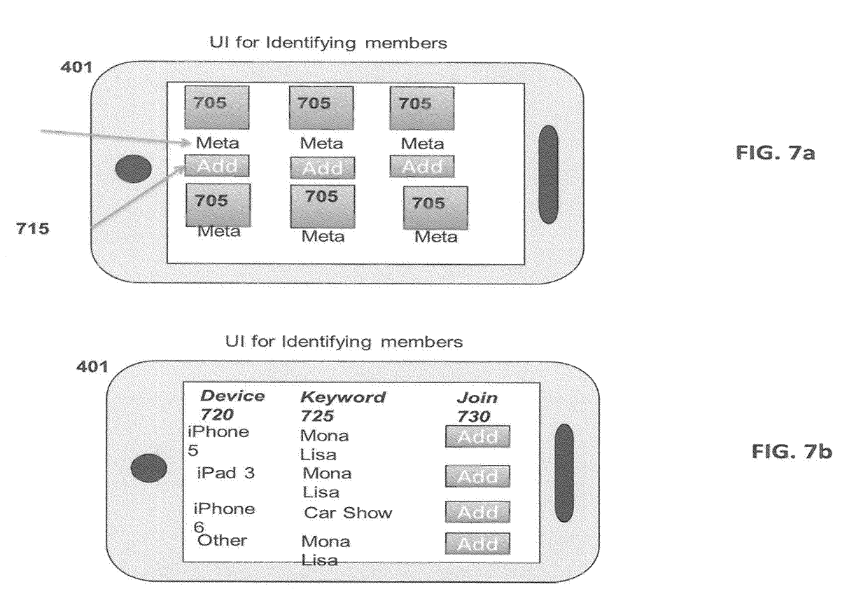

Once two or more users have indicated a general interest in a collaborative imaging project, a specific group may be formed through a user interface such as those shown in FIGS. 7a and 7b. FIG. 7a shows a sample user interface featuring, for each interested user, graphic information 705, metadata 710 and an “add” button 715. With the interface of FIG. 7a, a user may simply indicate the other devices chosen to be invited to the specific collaborative imaging group. The graphic indicators 705 may show anything useful for the users to find and identify each other. For example, the graphic indicators may represent a picture of the user, a picture of the desired subject, or a key picture used to uniquely identify a putative group of users. Furthermore, in some embodiments, multiple pictures may be used as graphic 705, such as, for example, both a picture of the desired subject and a picture of the user. The user interface shown in FIG. 7a also may include metadata such as device location, device model number, device name, hardware capabilities of the node, sensor reading, or any information available to a device that may aid group members in identifying and selecting other group members. Metadata may be textual or graphic; for example, the graphics 705 may be shown on a map, so that users may identify the location of other users. “Add” button 715 may be used to add the user to the specific group or to invite the user to the specific group. In alternative embodiments, a gesture upon the graphic 705 may be used as a substitute for the “add” button 715.

FIG. 7b shows a different user interface in the form of a list. The interface of FIG. 7b may include any of the information discussed with respect to FIG. 7a, although a particular example is shown in FIG. 7b. As illustrated in FIG. 7b, columns may be used for the list, such as, for example, a device ID column 720, a keyword column 725, and a join column 730. In varying embodiments, the device ID column 720 may identify the user's device by number, name, user name, hardware capability, or any descriptive word. In addition, the keyword column 725 may identify the subject or venue or may simply be a word chosen so users can identify each other. Finally, the “join” column 730 allows users to add to the group (or invite to the group) the devices described through the information in the other columns.

In some embodiments, when a node/user is added to a group, for example through the interface of FIG. 7a or 7b, the node/user may receive an invitation to join a specific group. As discussed above, in some embodiments, nodes are supervised, controlled, or managed by other nodes (e.g. in a master-slave or other arrangement illustrated below). In one embodiment that includes supervisory relationships, when a node/user is added to a group, that node/user may receive an invitation to join a specific imaging collaboration project or group. For example, after indicating a general desire to join a collaborative imaging group or project (the indication perhaps being as simple as running the collaborative imaging application), the node may be invited to join a specific group by a server or other node. In some embodiments, the invited node/user must accept the invitation in order to participate. The acceptance of an invitation may indicate the node's/user's consent to being managed or controlled by a supervisory device such as a master node or a managing node. In some embodiments, in order to solicit consent or agreement, an invitation may be sent to each node that will experience supervision or control. In order to advise a supervised node/user regarding the controls of the proposed supervision, the user interface may be employed, for example, to textually describe the controlled features. In one embodiment, the GUI may use images or video to describe controlled features.

An invitation may be sent by any node to any other node. In some embodiments, a supervisory node, such as a master node or a managing node, may send invitations to other nodes. In other embodiments, a server may send the invitations. Invitations may be generated in response to a user's action or, in some embodiments, they may be created by software after evaluating a situational context. For example, software on a node may recognize proximity of other devices, and, based upon the proximity, the software may decide to offer the users the ability to enter a collaborative imaging session, either generally or to a specific project. There are many factors that software may consider in determining whether a collaborative imaging session might be offered to other nodes/cameras. For example, software may consider location information combined with calendar, map, and/or public event information to determine if a group of nodes/cameras is in a place and/or at a time when an event suitable for imaging is taking place. For purposes of this feature, other applications on a node/device may allow a user to flag an event that should be considered for collaborative imaging. Some examples of such other applications are a reminder application or a calendar application wherein an express entry can be made to flag an event as appropriate for group imaging. This entry may be a check box or a pull-down selection on an appointment or reminder. Alternatively, the reminder or calendar application information may be used to infer whether a situation is appropriate for a collaborative imaging project. For example, the collaboration application may search the reminder or calendar application for a keyword such as “collaboration” or any user defined word. In this manner, the user may flag collaboration-appropriate events in reminder or calendar software that is not specially adapted. In addition to searching the reminder and calendar data, the collaboration application may register to receive notice of the certain types of entries when they are made into those applications.

Similarly to calendars and reminders, web pages and web-based directories or a web-accessible database can employ flags or other indications regarding collaborative image desirability and permissibility. For example, events or attractions listed or otherwise promoted on the internet may embed (visibly or not) GPS information and an entry indicating the desirability of collaborative imaging. The collaboration application may access the web-based content so that the node user may be notified of the opportunity.

Referring again to FIG. 6, block 615 identifies a mechanism for control or synchronization of information between group members. In particular, the member nodes of a group may accurately synchronize their time so time-based operations and functions may benefit. Furthermore, some embodiments may use a supervisory (e.g. controlling or managing) node that may be selected through user interfaces such as those shown in FIGS. 7a and 7b. For example, the user/device that selects group members may be the default supervisory node/user. Alternatively, after the group is identified, a user interface similar to those shown in FIG. 7a or 7b may be used to select or vote for a supervisory node/user. For these purposes, the collaborative imaging application may open a group chat session or audio conference call for all member devices to allow discussion. Of course, the embodiment may incorporate any known or derived mechanism to select a supervisory node/user.

In some embodiments, each node/user may register to participate in collaborative imaging. The registration may provide consent to use location information of the node and, in addition, provide an indication of a collaborative imaging interest either in text or graphic/photo (e.g. a performer, sports event/game, artwork, or even civil infrastructure—the Golden Gate Bridge). In one embodiment, a networked/Internet based server may maintain the identity, location, and imaging interest of each participant and may make the information available so that groups may be formed through user interaction with the collaboration application 410 (e.g. as shown in FIGS. 7a and 7b). In some embodiments, either server software or the collaboration application may attempt to automatically form imaging collaboration groups using information maintained at the server (e.g. a group of geographically close devices with similar or identical imaging interests). When a group is identified by the software, the various users may be prompted by notifications on their devices. A user can then choose to join the group or decline (e.g. using interfaces similar to FIGS. 7a and 7b, where the subject is identified and a user is only given a “join” button to indicate his or her own interest in joining).

The supervisory arrangement of a collaborative imaging project may take many different forms. In some embodiments, a master-slave arrangement may be employed. In a master-slave arrangement, a single node: (1) receives and assembles all the relevant information for an imaging session from each member node (e.g. sensor and image information from all the cameras); (2) controls all the camera settings of all the cameras/nodes; and (3) sends the capture signal(s) to capture still images or begin and end video recording.

In other embodiments, the collaborative arrangement may be more peer-to-peer in nature and generally lacking supervisory functionality. In a peer-to-peer arrangement, each node/device/user decides its own settings and/or its own capture time and the images are sent to a single device or a server for processing (e.g. fusing, stitching, or other combination).

Still other embodiments may use a hybrid form of control. In a hybrid arrangement, each node/device/user controls some functions and parameters while a managing server or node/user controls others functions and parameters. In one such embodiment, individual nodes may decide exposure settings because they can most quickly react to exposure conditions. A managing node/user may be sent the exposure information and may be given the ability to override a member exposure setting (e.g. for creative reasons), but absent an override the managed unit will control. Finally, in a hybrid arrangement, the managing node/user may decide the capture time(s) for a still image or video recording.

In some supervisory embodiments, control may be shifted between nodes or users either on a temporal basis, for functional reasons, or upon user request. In these embodiments or any others, the supervisory node may receive its authority by holding a control token. Tokens are a common networking construct and the skilled artisan will understand how to implement a token-sharing system, including such a system with multiple tokens where each token represents a different function.

Referring again to FIG. 6, at block 620 video or one or more images are captured. Captured images and video may be for preview purposes or for the purpose of producing a collaborative result image. In some embodiments, a preview function may provide that images and/or video are sent continuously or periodically to a supervisory node or server. The preview information may be used to make adjustments to the positioning and settings of cameras/nodes in the group. Either before or after acquiring preview information, a supervisory node may distribute capture settings (aperture, exposure, etc.) and orientation instructions to the group members. The supervisory node may use the preview information to evaluate the effects of the distributed settings and instructions and then iteratively continue to change settings and instructions until satisfactory conditions are achieved. In one embodiment, preview capture properties may be used, for example, in difficult lighting situations where one camera is backlit and the other is sun-drenched. By allowing the supervisory node to control the capture settings, the effects of difficult light can be mitigated or used artistically to the user's preference.

During or after any preview period, an image or video may be captured for use in the collaborative image result. There are several embodiments regarding the manner in which images are captured for use in the collaborative result. Depending upon the embodiment, not all nodes will necessarily capture images. In some instances a functional or creative decision may be made to exclude a node and in other instances, a node may be used only for the data it provides to aid in the overall process (i.e. even if captured, image data may not be used from every node).

In one embodiment, all devices may capture an image or video and record associated metadata. For example, in addition to the image or video data and any camera-related metadata (e.g. focal length, aperture, etc.), a node may record sensor data, clock data, battery data, user preference data, and any other information that may be useful in combining the captured images/video. Any data, including sensor data or user input relating to relative and absolute positioning of the camera, may be used to combine the plurality of images or video (e.g. GPS, magnetometer, accelerometer, etc.) Of course, this data may also be employed in a preview mode where the collaboration application may use a GUI to display an assumed relative positioning (e.g. on a map) of the group of cameras and the user may be asked to correct his or her node position or all node positions by dragging to a different (more correct) position.

In one embodiment, all the cameras/nodes may simultaneously capture images in order to record the subject at a single instant in time. Other embodiments provide for temporal sequencing of capture times. In these implementations, instead of having simultaneous capture, each camera or sub-group of cameras may capture its image(s) or video at designated times. Embodiments of this nature allow the individual images or video to be separated in both geographical space and time. For example, if the subject is moving, sequential triggers could provide an artistic visualization or follow the subject through its motion, appearing like an artistic video of the motion. Furthermore, if the cameras capture video instead of still images, individual frames from each camera's video can be selected in post-capture processing to achieve a wider variety of results at the discretion of the user.

Referring again to FIG. 6, block 625 shows that the captured video or images may be shared so one or more collaborative results may be created (e.g. combined images). When a collaborative group is using a supervisory arrangement, some embodiments may require that each camera/node forward its image(s) or video to the supervising node for handling and/or processing. The image information may be sent directly or through a wide area network. In the latter arrangement, a server on the WAN may be used to assist with processing during transmission of the information (e.g. the images may be partially or totally processed by a server on the WAN prior to arriving at a supervisory node). The use of this type of interim processing may be initiated by selection from a GUI on the supervisory node. The same GUI may be used to determine the type and extent of interim image processing that the server will perform. For example, the server may stitch or fuse images or create a model of the images that allows for easier or better fusing or stitching on the supervisory node or other node.

In many embodiments, pre- and post-capture image and device properties may be shared or synchronized along with the image information. For example, all sensor information and camera settings may be distributed for use in image processing or in combining the images (e.g. stitching or fusing). In one embodiment, images may be shared in RAW form so, in order to process the images, sensor and camera information must be shared. While RAW images are large, they allow the most flexibility in post-capture processing.

Referring again to FIG. 6, block 630 relates to combining the group's images in a post-capture operation. The combined image may be any combination of information from two or more of the captured images or videos. In some embodiments, the goal of combining images may be to stitch multiple images together to capture more of a subject (or set of subjects) than one camera may be able to capture. Alternatively, the combined image may be a collage of images from two or more of the participating cameras. These embodiments may be suitable, for example, when the nodes are significantly geographically separated and/or the subject is not identical for each image. In yet other embodiments, images may be fused in a way that intentionally overlaps image information for artistic or other reasons. Finally, the combined image may be any combination of the forgoing techniques.

Image combinations may also change character of the image information. For example, the varying images may be used to develop depth information relating to the subject. For example, multiple images captured from different angles provide depth and perspective information that may be useful for developing 3D images, models or scenes, or other types of image forms that exploit or expose depth and perspective information (e.g. disparity imaging). In one embodiment, the depth and perspective information may be employed to create images similar to those created by light-field or plenoptic cameras; this may provide users with the ability to perform focusing operations after the image is captured. In embodiments where this is the goal, a supervisory node (e.g. server or camera) may direct the settings and placement of the cameras and, in some embodiments, may retrieve multiple image captures from each of one or more of the group members. In one particular embodiment, a plenoptic lens effect may be achieved by: (1) setting all the nodes at the same focus level; (2) registering image or video feeds so they are all pointing at the same subject; and (3) intentionally sending focus parameters to make each node focus at different levels and snap one of more pictures at each focus point, potentially using multiple focus points for each node. The collected information may be processed by a server or supervisory node to produce a plenoptic image file or other information that may simulate post-capture focusing.

Referring again to FIG. 6, at block 635, the final or post-processed image may be shared. Depending upon the embodiment, the final image may be forwarded directly to one or more other nodes or may be uploaded to the web for distribution. In addition, the result image may be automatically uploaded to social media or photo sharing websites such as ICLOUD®, FACEBOOK®, TWITTER®, or FLICKR®.

### Communication Between the Cameras/Nodes

According to differing embodiments, the nodes may communicate by any mechanism known now or in the future. For example, any network available on a smartphone or tablet may be convenient, such as WiFi, Bluetooth, or a cellular network. Furthermore, as discussed above, communications may be direct or through network equipment/computers and/or a server. Moreover, all the nodes may not use the same communications network or protocol. For example, nearby nodes may use a PAN while geographically-distant nodes may use a cell network.

Since many embodiments of the invention envision communication between and among several nodes, a communications protocol may be desirable to ensure that the nodes receive all the intended messages. Many satisfactory protocols are known to the skilled artisan. For example, one embodiment may use a token system where a device must have an electronic token to send communications. The token may be passed in a ring or other system in order to organize communication between and among the participants.

### Arrangement of the Cameras.

The arrangement of the nodes can vary greatly and can be left to the creativity of the photographers. The examples shown in FIGS. 5a and 5b (discussed above) are viewed as likely common arrangements for a collaborative imaging project. However, there are limitless possible camera arrangements that may be employed for practical, functional or artistic reasons. In one embodiment that is illustrated in FIG. 5c, the nodes/cameras 401 may be at various distances and angles from the subject 510 so that the perspectives vary in both depth and angle. This type of arrangement can generate images that may be combined or post-processed to produce depth information as well as 3D aspects.

Another interesting arrangement may be to synchronize image capture in time but not in location. For example, a group of friends could take pictures at the exact same time but in different parts of the country or world, thus sharing a common experience in time. In this case, the combined image may be more suitable to a collage, but the choice of fusing and stitching may be left to the users.

In yet another embodiment, geographically-separated nodes may capture images in an absolute time sequence such as minutes or seconds apart or even at the same local time. Moreover, time-separated capture sequences may be useful at live events where the collaborative group desires to track moving objects and the members of the group are arranged in the path of movement (e.g. 10 group members at a race track following a car or group of cars; or 5 members at a basketball game following a fast break). In different time-separated capture sequences, sensor data, such as time of day, GPS information, event information, and map information may be useful. For example, the collaboration application may use GPS, time, location, and event information to prompt each user to take a picture at their evening meal (text or graphics can be used to prompt the user regarding the image subject, and/or image analysis can be used to verify or identify the image subject).

### Understanding the Physical Node Arrangement.

Information regarding the physical node arrangement (e.g., the relative location of nodes and the direction of each lens) may be useful in pre-capture adjustments and post-capture processing operations. In order to determine the lens position and relative location of the nodes with respect to each other and the subject, a combination of sensor data and user input data may be used. In one embodiment, each of multiple devices may try to determine its relative position with respect to other nodes and the subject. After making such an attempt, the device may share with other nodes (or a supervisory node) both its source data (e.g. sensor data) and its conclusions regarding relative positioning. The shared data may speed or improve the final result calculated by a server, a supervisory, node or a combination thereof. Differing embodiments of the invention envision any one or more of the following techniques and information sources that may be used to estimate relative position and lens direction of other nodes: signal strength; audible signals broadcast by nodes at a scheduled time and received by other nodes at a relative time; audible signal measurement where different nodes use different frequencies of sound; a GUI on each node may be used to cue users to move their node or signal to the remainder of the group (e.g. raise a hand); and, any accessible data available from computing devices within or proximate to the nodes but not participating in the collaborative imaging project.

### User Interface for a Supervisory Node.

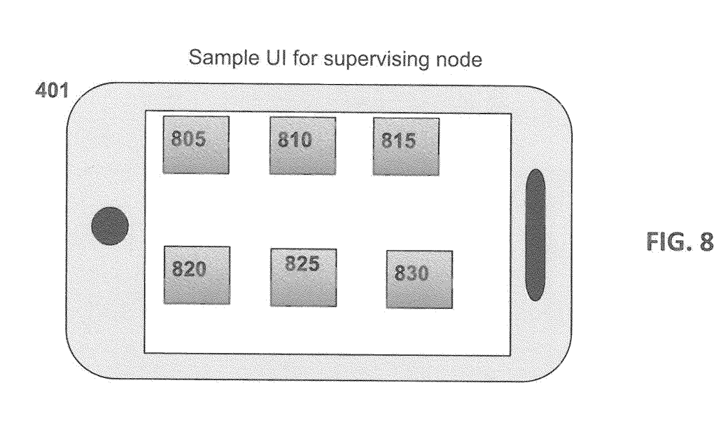

In some embodiments using supervisory nodes, the GUI on the supervisory node may display the camera view of every camera in the group. An illustrative example of this arrangement is shown in FIG. 8, where each image/video feed originates with a node (all the other nodes plus a feed for the supervisory node if it is being used to capture image data). FIG. 8 shows feeds from six group nodes 805, 810, 815, 820, 825, and 830. The size of the feeds may be adjusted in the GUI (e.g. with a pinch) or through preferences. If all the feeds do not fit on one screen, they may be accessed by scrolling or any other known method. In addition, the GUI may allow the user of the supervisory node to select a feed (e.g. by a touch and hold gesture or other gesture) and activate a tool kit to control aspects of the supervised node operation and/or camera operation (e.g. focus, position, or tilt of the camera and node). The same or a similar gesture may be used to send instructions to a node. Finally, in some embodiments, the control signals and instructions to a node may be accessed through the same tool set.

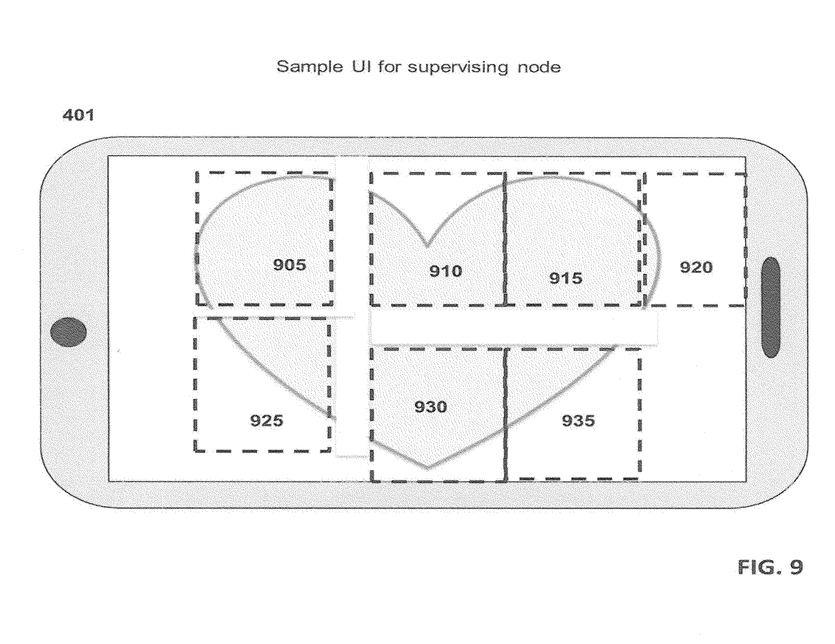

A toolset for each node may provide a variety of capabilities for the operator of a supervisory node. For example, the supervisory node's view of the feeds may be real-time or near-real-time so that adjustments made to the camera setting or node position and tilt may be evaluated by reviewing the image data that results from those changes. In some embodiments, the supervisory node may additionally receive feedback in the form of a post-processed combined image. For example, with reference to FIG. 9 a supervisory GUI is shown with feeds from 7 cameras shown in dotted lines, 905, 910, 915, 920, 925, 930, and 935. The feeds reveal that the subject is a heart graphic, but that not all portions of the heart are captured by the available nodes. In particular, viewing FIG. 9, it is evident that portions of the heart are whited out because they are not provided by any of the feeds. In some embodiments, the user may set preferences to automatically highlight these areas (gaps) and provide suggestions to close the gaps in the image (e.g. which node to move and how). Similarly, in some embodiment, the software may be programmed to highlight portions of the combined image where two feeds overlap significantly (over a pre-determined threshold), and to make suggestion so that multiple cameras are not wasted by substantially capturing the same portion of a subject. The software-generated suggestions may be provided graphically (e.g with arrows) or text or both (e.g. an arrow and text that says “move 2 feet to the right”).

The user interface of FIG. 9 may allow the supervisory node and/or its user to direct the settings, positions, and tilts of the other nodes in order to capture the desired subject—in this case the entire heart. In most embodiments, the feeds may similarly reveal image quality so the desirability of camera setting changes may be easily evaluated at the same time as position and tilt. In one embodiment, the supervisory GUIs may be available on other nodes in the group to aid in the organization and positioning process.

Depending upon user preference and/or the size of the supervisory node screen, the GUI types of FIG. 8 and FIG. 9 may be simultaneously available or may be used in alternating fashion by application of a gesture to the touch screen of the node. In addition, a user may wish to closely evaluate only one feed so the GUI allows the selection of any particular feed to consume the whole screen or a half screen.

In some embodiments, the real-time or near-real-time feeds may be reduced in resolution or highly compressed in order to speed processing and transmission. In addition, the combined image GUI of FIG. 9 may be only partially processed—enough to give the viewer a reasonable editing opportunity but not enough to over-consume processing, power, or transmission resources. In some embodiments, the quality/resolution/compression factors may change according to the amount of data destined for the screen. By dynamically adjusting these factors, the software may provide the best practical preview information without over-taxing processing, power, or transmission resources.

Some embodiments of the invention may use one or more communication tokens to define the level of communication that a particular node can have with the organizer. In a multiple token situation, different tokens may represent different forms of communication: a token for voice communication; a token for video feed; a token for still image feed; and a token for sending instructions to other nodes.

In cases where cameras are geographically disbursed, the nodes or the supervisory node may present a GUI that overlays the feeds shown in FIG. 8 over a map showing the location of the nodes/cameras. This information may be useful in a wide variety of situations, for example, at a football game to determine and/or understand placement around the field. As another example, the map GUI may be useful to apply to a dozen cameras spaced across the world.

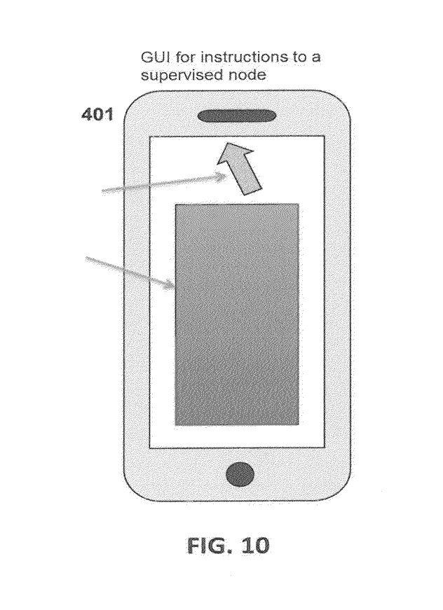

In accordance with some embodiments, each supervised node may display a GUI or may allow audio information to inform the user of a supervised node regarding instructions from the supervisory node. In one embodiment, suggestions or instructions from the supervisory node may be received by a supervised node and may be graphically displayed (e.g. by arrows or by placing a goal box on the low-res combined image) or may be displayed in text or both. An example of such an interface is shown in FIG. 10 where arrow 1005 shows a direction to move object 1010, which may graphically represent either the node device or the image being captured by the device. Alternatively, the GUI may display a video showing the desired motion for the device. In some embodiments, the nodes may employ an audible communication feature so that there is audio communication to inform the user of the supervised node of the desired action. This may be, for example, the voice of the supervisor node user or a pre-stored voice, similar to Apple Inc.'s SIRI®. The audio embodiments may be particularly useful for users that are holding the nodes in a way that makes the screen difficult to see.

With reference to FIG. 9, the image feed previews may be provided in a combined form that may be selected or arranged by the user (fused, stitched, collaged, or otherwise). A supervisory node user can view the interface of FIG. 9 and determine that changes are desirable, such as, for example closing the gaps so that the whole heart is visible. In some embodiments, based upon user setting and/or analytical algorithms, the collaborative imaging application may make suggestions to the organizer or each individual node for position adjustments to close the gaps in the combined image. In one embodiment, if the suggestions of the software are approved by the supervisory node, the software may automatically provide corrective instructions to the group members. In another embodiment, the corrective instructions may be updated iteratively as the user attempts to follow the previous instructions (the preview of the result image may be monitored and instructions may be updated in view of the changing preview image).

In another set of embodiments, the supervisory node user may use the GUI of FIG. 9 to move the feeds around the screen so they are in the desired position. When the supervisory user moves the feed, in some embodiments, the feed may be represented by two graphics—one for the actual position of the feed and another for the desired or target position of the feed. By dragging the feed on the supervisory GUI, the user may prompt the software to calculate the positioning or other changes needed in the associated node to effect the desired/indicated change to the combined image. These calculations may be performed on the supervisory node, on the supervised node, or on a server. The results of the analysis may be forwarded to the subject node and the collaboration application on the node may instruct the user to make the changes. The software may continually monitor the position of the actual feed with respect to the target position and may iteratively and automatically instruct the user. Furthermore, in some embodiments, the supervisory node user may manipulate several nodes at the same time and may have the software manage the instructions to effect the desired changes.

In yet another embodiment, the automated iterative software assistance discussed above can be used to assist the user of a supervised node in maintaining the camera at the desired position. For example, once the supervisory node indicates that a node's position is correct, the software may treat that position as the target position and consistently provide instructions to the user of the supervised node regarding the maintenance of that position.

In another embodiment, subject to user preferences and settings, each node's GUI may provide a preview of the combined image with a highlighted box showing the node's contribution to the combined image. This embodiment may aide the users of supervised nodes in holding or finding a desired camera position.

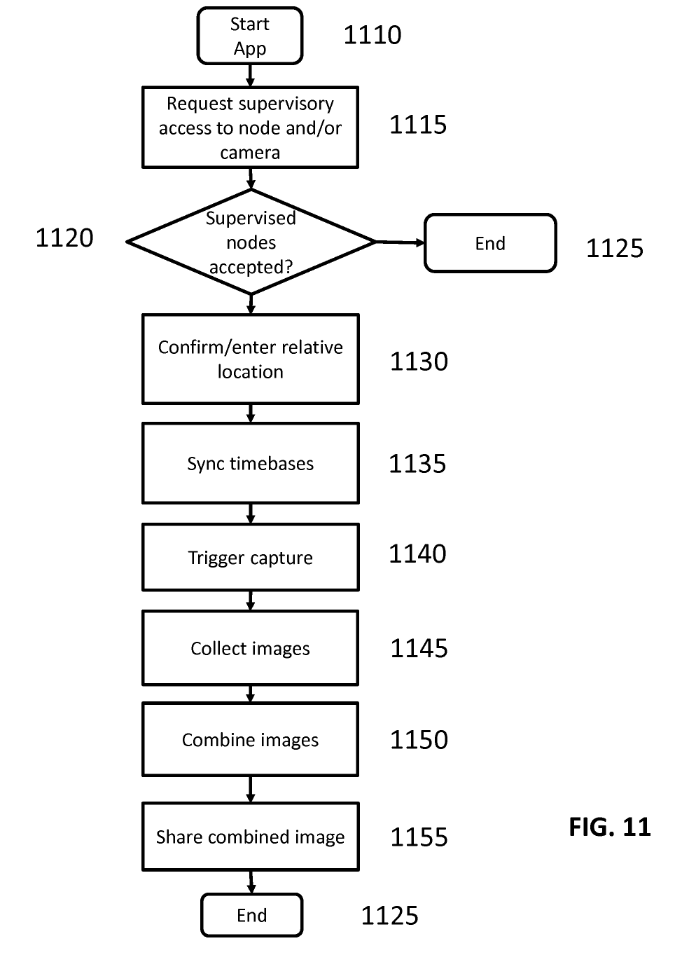

Referring now to FIG. 11, a more particular process is shown for entering and employing a collaborative imaging session. At block 1110, the collaborative imaging application or other capable software (including potentially low-level software alone) may be started on a supervisory node and any nodes that may become part of a collaborative imaging group. At block 1115, the supervisory node may request supervisory access to other nodes. Supervisory access may include the ability to control camera aspects as well as non-camera aspects of a node. At decision block 1120, if the putative supervised nodes do not accept the supervisory control, then the process ends for those devices. For the devices that accept supervisory control, the process continues at block 1130 where the relative location of each device is determined or confirmed. At block 1135 the time bases for all group nodes may be synchronized so that precise relative timing may be used for imaging and positioning operations. At block 1140, one or more still images or video may be captured by each node. Next, at block 1145, the images may be assembled at the supervisory node, at another node, or at a server. At block 1150, the images may be combined and, at 1155, the combined image may be shared with the participating nodes or with various Internet-based services.

It is to be understood that the above description is intended to be illustrative, and not restrictive. The material has been presented to enable any person skilled in the art to make and use the invention as claimed and is provided in the context of particular embodiments, variations of which will be readily apparent to those skilled in the art (e.g., many of the disclosed embodiments may be used in combination with each other). In addition, it will be understood that some of the operations identified herein may be performed in different orders. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. An electronic device comprising:
a lens;
an image sensor in optical communication with the lens;
a processor in communication with the image sensor;
a display for providing a user interface; and
communication circuitry under control of the processor and configured to transmit and receive positional information associated with at least one of the one or more secondary devices,
wherein the user interface is configured to display information derived from output of an image sensor of at least one of the one or more secondary devices, and
wherein at least one aspect of the image sensor of the at least one of the one or more secondary devices is based upon at least a portion of the transmitted positional information.

2. The electronic device of claim 1, wherein the communication circuitry transmits an invitation to the one or more secondary devices and receives a response to the invitation comprising an assent to supervisory control by the electronic device.

3. The electronic device of claim 1, wherein the aspect of the image sensor that is based upon at least a portion of the transmitted positional information is an angle of the image sensor with respect to a subject.

4. The electronic device of claim 1, wherein the communication circuitry receives preview image information from a plurality of the one or more secondary devices and displays upon the display of the electronic device the preview image information received from at least the plurality of the one or more secondary devices.

5. The electronic device of claim 4, wherein the displayed preview image information is displayed relative to map information that shows a location for each of the plurality of the one or more secondary devices providing the respective preview image information.

6. The electronic device of claim 4, wherein the displayed preview image information is displayed as a combined image, where a contribution from each of the plurality of the one or more secondary devices is visually identifiable.

7. The electronic device of claim 6, wherein the user interface is adapted to receive input upon the combined image to adjust a relative position of at least one contribution from a first of the plurality of the one or more secondary devices; and in response to the input upon the combined image, the processor is programmed to determine a positional change for the first of the plurality of the one or more secondary devices, where the positional change corresponds to the input upon the combined image.

8. The electronic device of claim 7, wherein the processor determines the positional change by using a network-based server to perform calculations.

9. A method comprising:
using a processor to send a first message through communications circuitry, the first message to identify one or more nodes to participate in a collaborative imaging project;
receiving, through the communications circuitry, first information for each of the one or more nodes, wherein the first information comprises identifying information regarding the node and information regarding a hardware capability of the node;
in response to receiving the first information, presenting, through a user interface, a first indication for each of the one or more nodes from which the first information was received;
receiving input regarding at least one of the first indications;
in response to the input regarding at least one of the first indications, using the communications circuitry to send an invitation to each of the one or more nodes corresponding to the received input;
receiving, from at least a plurality of the one or more nodes, image information reflecting each node's real time image capture; and
creating a combined image from the received image information.

10. The method of claim 9, wherein the first message queries a server.

11. The method of claim 9, wherein the first message relates to a network service discovery tool.

12. The method of claim 9, wherein the information regarding the hardware capability of the node is a model number of the node.

13. The method of claim 9, wherein the user input regarding at least one of the first indications comprises closing or narrowing a gap in the combined image.

14. The method of claim 9, further comprising receiving an assent to supervisory control from each of the one or more nodes providing image information prior to the provision of image information.

15. The method of claim 9, wherein the user interface displaying the first indication for each of the one or more nodes from which first information was received is the combined image and wherein each first indication is a representation of the real-time images captured on a corresponding node.

16. A non-transitory computer-readable medium comprising one or more instructions that when executed on a central processing unit (CPU) configure the CPU to:
send a first message through communications circuitry, the first message to identify one or more nodes to participate in a collaborative imaging project;
present a user interface displaying a video feed for each of the one or more nodes supplying real-time image information for previewing, the video feeds organized in the form of a combined image where each video feed may be distinguished from the others;
receive user input regarding at least one of the displayed video feeds; and
in response to the user input, send through the communications circuitry a message to cause a positional change to a node corresponding with the received user input.

17. The non-transitory computer-readable medium of claim 16, wherein the first message is an invitation.

18. The non-transitory computer-readable medium of claim 16, wherein the combined image is either a stitched image or a collage.

19. The non-transitory computer-readable medium of claim 16, wherein the positional change is calculated by software based upon the user input.

20. The non-transitory computer-readable medium of claim 19, wherein the message to cause a positional change is sent automatically in response to the received user input.
